(19) United States
(12) Patent Application Publication
(10) Pub. No.: US 2026/0090536 A1
(43) Pub. Date: Apr. 2, 2026

(54) INTELLIGENT BIRD EXPULSION METHOD AND SYSTEM

(71) Applicant: iCHASE Co., Ltd., Taipei (TW)

(72) Inventors: LI-WAN HUANG, Taipei (TW); TA-WEI CHIEN, Taipei (TW); KUANG-FU CHANG, Taipei (TW)

(21) Appl. No.: 19/347,760

(22) Filed: Oct. 2, 2025

Related U.S. Application Data
(60) Provisional application No. 63/702,199, filed on Oct. 2, 2024.

(51) Int. Cl. A01M 29/26; A01M 29/12; A01M 29/16; A01M 29/20; G05D 1/689; G06V 10/94; G06V 20/17; G06V 20/52; H04N 23/69; H04N 23/695

(52) U.S. Cl. CPC A01M 29/26; A01M 29/12; A01M 29/16; A01M 29/20; G06V 10/95; G06V 20/17; G06V 20/52; H04N 23/69; H04N 23/695; G05D 1/689

(57) ABSTRACT

Embodiments of the present invention provide an intelligent bird expulsion method and system capable of effectively identifying and expelling birds by combining a moving mechanism and an intelligent image determination model. Firstly, the moving mechanism is controlled to move according to a user-preset position, and an image is captured at a designated location. Subsequently, the intelligent image recognition model is utilized to determine locations of the birds, based on which a movement pattern and an activation timing of an expulsion device are determined, and an expulsion strategy is formulated and implemented. Another image is captured after the bird is repelled, and an expulsion effectiveness is evaluated by comparing the images captured before and after expelling the birds. Finally, the system stores a result of evaluating the expulsion effectiveness as historical data and performs strategy review and optimization.

### FIELD

The present invention relates to a bird expulsion technology and, more particularly, to a method and system for automatically expelling birds based on intelligent image capture and recognition.

### BACKGROUND

In the technical fields of preventing avian influenza and reducing feed losses, existing technologies generally rely on manually preset expulsion methods, such as the use of acoustic devices, fake eagles, flashing devices, or other visual and auditory stimulation means to repel birds. However, these methods suffer from several significant drawbacks. The maintenance and operation of these devices require manpower and incur costs, thereby increasing the management burden on farms, which is particularly disadvantageous for large-scale breeding farms. Generally speaking, traditional manually preset bird expulsion methods struggle to cope with dynamic bird behaviors and environmental conditions, and they suffer from deficiencies such as diminishing effectiveness, resource wastage, and epidemic prevention risks.

FIG. 1 illustrates a schematic view of a bird expulsion device in the prior art. Referring to FIG. 1, the bird expulsion device includes a moving mechanism 100, a camera device 101, and a laser emitting device 102. The bird expulsion device can be programmed with several different modes to control the moving mechanism 100 and the laser emitting device 102. In addition, each mode can be assigned to a specific time slot, thereby implementing various bird expulsion modes at different times of the day. The results are observed through the camera device 101.

However, since the method for expelling birds mostly relies on preset parameters and lacks real-time adaptive capabilities, it is difficult to make adjustment based on different bird species or current conditions, resulting in limited expulsion effectiveness. Birds possess high learning and adaptive abilities and easily develop habituation to fixed and repetitive stimuli, consequently ignoring these expelling means and rendering them ineffective. In addition, current bird expulsion devices mostly operate passively, making it difficult to react in real time according to the actual activity periods or intrusion paths of bird flocks, thereby reducing disease prevention efficiency. Therefore, there is an urgent need for bird expulsion technology to develop towards intelligence and dynamic adjustment.

The currently commonly adopted patrol modes, such as the camera device 101 scanning at fixed angular intervals, are not only time-consuming but also inefficient. Such mechanisms often expend significant resources on areas where no birds are present, missing opportunities for immediate expulsion. At the same time, such mechanisms cannot concentrate resources on hot zones where birds frequently gather to perform intensified monitoring and expulsion, causing overall effectiveness to be greatly compromised. Furthermore, traditional bird expulsion technologies lack real-time safety identification mechanisms. When non-target objects such as personnel, vehicles, or livestock appear within the expulsion range, the system cannot identify them and cease operation, leading to potential disturbance or even injury to humans and animals caused by the acoustic or optical expulsion devices.

### SUMMARY

One object of a preferred embodiment of the present invention is to provide an intelligent bird expulsion method and system that utilizes imaging technology to determine information such as bird locations and counts, and formulates a strategy to perform bird expulsion operation based on said information and the status of an expulsion device.

In view of the above, a preferred embodiment of the present invention provides a bird expulsion method. The bird expulsion method includes: setting, via a control device, at least one expulsion location; orienting, via a moving mechanism, a lens of an image capturing device toward the at least one expelling location; performing, via the lens of the image capturing device, a first image capture on the at least one expulsion location to obtain a first image; determining, via an intelligent image determination model, locations where a plurality of birds are present within the first image; determining an activation of an expulsion device and a movement pattern of the moving mechanism based on the locations where the plurality of birds are present; determining an expulsion strategy based on the expulsion device; performing the expulsion strategy via the expulsion device and the moving mechanism; performing a second image capture to obtain a second image after performing the expulsion strategy; analyzing, via the intelligent image determination model, the second image and the first image to obtain expulsion effectiveness evaluation data; storing the expulsion effectiveness evaluation data; and performing a strategy review calculation based on the expulsion effectiveness evaluation data to change the expulsion strategy.

Another preferred embodiment of the present invention provides a bird expulsion system. The bird expulsion system includes a moving mechanism, an image capturing device, an expulsion device and a control device. The image capturing device is disposed on the moving mechanism. The expulsion device is disposed on the moving mechanism, and the image capturing device and the expulsion device are substantially aimed in the same direction. The control device is coupled with the moving mechanism, the image capturing device and the expulsion device, and the control device includes an intelligent image determination model. The control device stores at least one expulsion location.

During operation, the control device controls the moving mechanism to orient a lens of the image capturing device toward the at least one expulsion location, and then the control device controls the lens of the image capturing device to perform a first image capture on the at least one expulsion location to obtain a first image. The intelligent image determination model is utilized to determine locations where a plurality of birds are present within the first image. The control device determines an activation of the expulsion device and a movement pattern of the moving mechanism based on the locations where the plurality of birds are present. Afterward, the control device determines an expulsion strategy based on the expulsion device. The control device controls the expulsion device and the moving mechanism to perform the expulsion strategy; and after the expulsion strategy is performed, the control device controls the lens of the image capturing device to perform a second image capture to obtain a second image. The intelligent image determination model is utilized to analyze the second image and the first image to obtain expulsion effectiveness evaluation data. The control device stores the expulsion effectiveness evaluation data. The control device performs a strategy review calculation according to the expulsion effectiveness evaluation data to adjust the expulsion strategy.

In order to make the above and other objectives, features, and advantages of the present invention more comprehensible, preferred embodiments are described in detail below with reference to the accompanying drawings.

### BRIEF DESCRIPTION OF THE DRAWINGS

The provided drawings are intended to enable those skilled in the art to further understand the present invention and are incorporated as part of the specification of the present invention. The drawings illustrate exemplary embodiments of the present invention and are used together with the specification to describe the principles of the present invention.

FIG. 1 illustrates a schematic view of a bird expulsion device in the prior art.

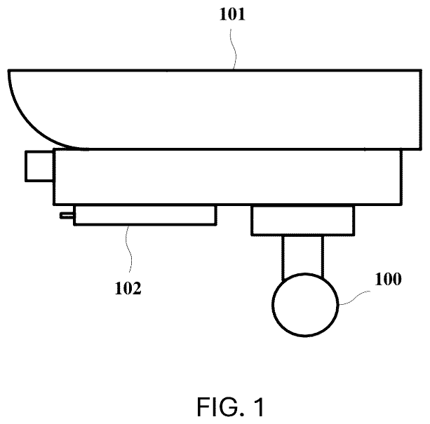

FIG. 2 is a schematic diagram illustrating a bird expulsion system according to a preferred embodiment of the present invention.

FIG. 3 is a schematic diagram illustrating a sequential scan of the bird expulsion system according to a preferred embodiment of the present invention.

FIG. 4 is a schematic diagram illustrating a focal coordinate scan of the bird expulsion system according to a preferred embodiment of the present invention.

FIG. 5 is a flowchart illustrating a bird expulsion method using the bird expulsion system according to a preferred embodiment of the present invention.

FIG. 6 is a schematic diagram illustrating a target expulsion area set for the bird expulsion system according to a preferred embodiment of the present invention.

FIG. 7 is a schematic diagram illustrating an aiming trajectory of an expulsion device 203 driven by a moving mechanism 201 of the bird expulsion system according to a preferred embodiment of the present invention.

FIGS. 8A to 8D are schematic diagrams illustrating expulsion strategies of an expulsion device 203 of the bird expulsion system according to a preferred embodiment of the present invention.

FIG. 9 is a flowchart illustrating an operation of the bird expulsion system according to a preferred embodiment of the present invention.

FIG. 10 is a schematic diagram illustrating an aiming trajectory of an expulsion device 203 driven by a moving mechanism 201 of the bird expulsion system according to a preferred embodiment of the present invention.

### DETAILED DESCRIPTION

Detailed reference will be made to exemplary embodiments of the present invention, which are illustrated in the accompanying drawings. Under possible circumstances, the same reference numerals are used in the drawings and the description to refer to the same or similar components. Furthermore, the exemplary embodiments are merely some of the implementations of the design concept of the present invention, and the following examples are not intended to limit the present invention.

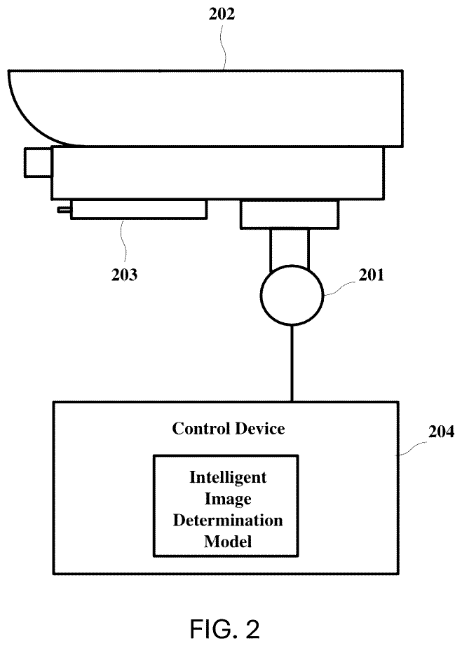

FIG. 2 is a schematic diagram illustrating a bird expulsion system according to a preferred embodiment of the present invention. Referring to FIG. 2, the bird expulsion system includes a moving mechanism 201, an image capturing device 202, an expulsion device 203, and a control device 204. In the present embodiment, the image capturing device 202 may be a video camera, a digital camera, an infrared camera, or the like; however, the present invention is not limited thereto. The image capturing device 202 is disposed on the moving mechanism 201, which is capable of free rotation. A preferred embodiment of the moving mechanism 201 is, for example, a control mechanism having Pan, Tilt, and Zoom (PTZ) capabilities. In the present embodiment, the expulsion device 203 is also disposed on the moving mechanism 201; for example, the expulsion device 203 is disposed together with the image capturing device 202 on the moving mechanism 201. In this way, the position, at which a lens of the image capturing device 202 is aimed, is substantially the position, at which the expulsion device 203 is aimed. In the present embodiment, the expulsion device 203 is primarily a device capable of aiming at a remote target, such as a laser module, a water gun, a directional acoustic device, an air gun, a sprayer, or the like.

The water gun is configured to perform an expulsion operation via water spraying. The acoustic device is configured to emit sound waves. The laser module is configured to emit laser light. The air gun is configured to perform a physical expulsion operation. The sprayer is configured to release chemical agents or water-based repellents. In the present embodiment, one or more expulsion devices 203 may be provided, and the specific configuration is primarily determined according to different circumstances or requirements of a client or a farm owner. In addition, in other preferred embodiments, the bird expulsion system may further include a non-directional expulsion device, such as a remote-controlled mobile device configured for a physical expulsion operation. This aspect is a matter of design choice, and the present invention is not limited thereto.

The image capturing device 202 and the expulsion device 203 are designed to be substantially aimed in the same direction. The control device 204 is coupled to the moving mechanism 201, the image capturing device 202, and the expulsion device 203. In the present embodiment, the control device 204 may be a small-scale computer or a computing machine, and internally includes an edge computing type of pre-trained intelligent image determination model. In the present embodiment, a device manufacturer can pre-train the intelligent image determination model according to different scenarios. For example, if a location for expelling birds is a roof, bird photographs of a roof scene are utilized to train the intelligent image determination model; and if the location for expelling birds is a cattle shed, bird photographs of a cattle shed scene are utilized to train the intelligent image determination model. The adoption of the edge computing type of intelligent image determination model primarily allows a user to apply the intelligent image determination model directly on an edge device without a need to connect to a server, thereby reducing computational latency and eliminating a need to consider issues such as communication security and efficiency, resulting in highly flexible applications.

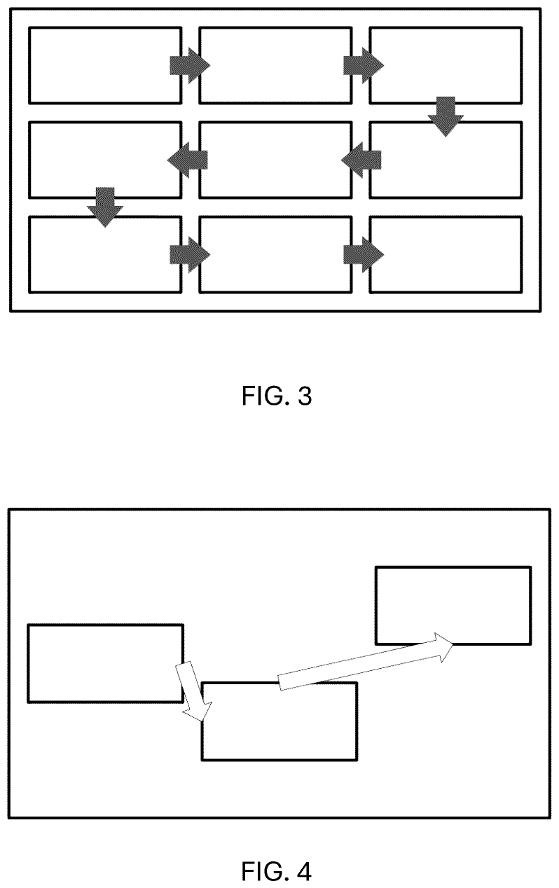

When no user setting is applied, a sequential scan mode is generally adopted. FIG. 3 is a schematic diagram illustrating a sequential scan of the bird expulsion system according to a preferred embodiment of the present invention. Referring to FIG. 3, in the present embodiment, the moving mechanism 201 can drive a lens of the image capturing device 202 to aim at a preset expulsion location in a sequential manner, grid by grid according to a fixed order, to complete an expulsion process, and subsequently proceeds to a next expulsion location. With such a preset configuration, the device can periodically move to scan an entire activity area; however, a disadvantage is that a significant amount of time is wasted scanning areas where no birds are present.

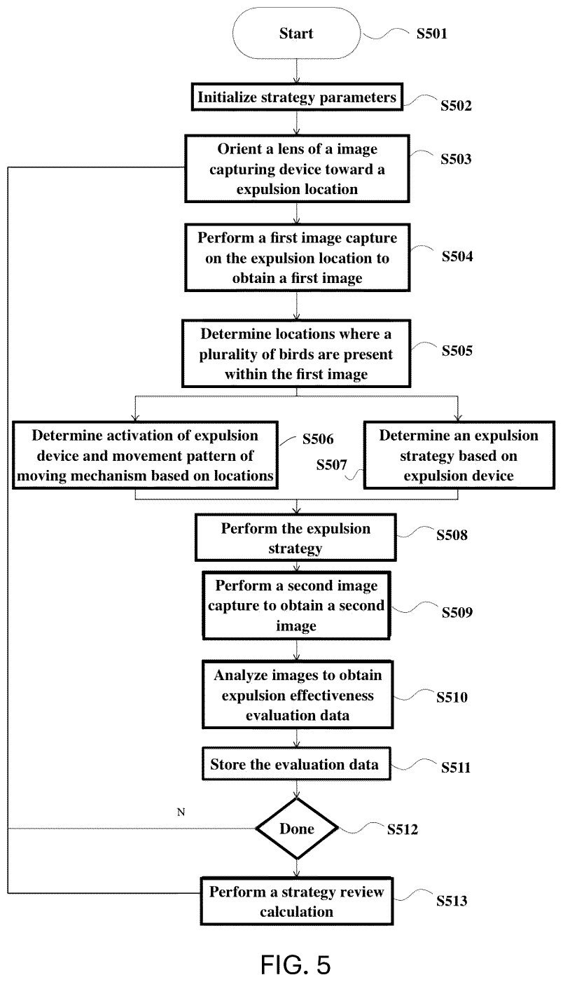

FIG. 4 is a schematic diagram illustrating a focal coordinate scan of the bird expulsion system according to a preferred embodiment of the present invention. Referring to FIG. 4, in the present embodiment, the user may manually designate regions within the activity area to set, for example, three bird appearance hotspots. By setting regular coordinate points to designate the regions, a plurality of coordinate points can be selected as periodic expulsion points. These coordinate points can be automatically activated according to a preset time of the system, and the system automatically selects a regular coordinate point closest to an expulsion target as part of a path. In this manner, the effectiveness of each expulsion operation can be improved.

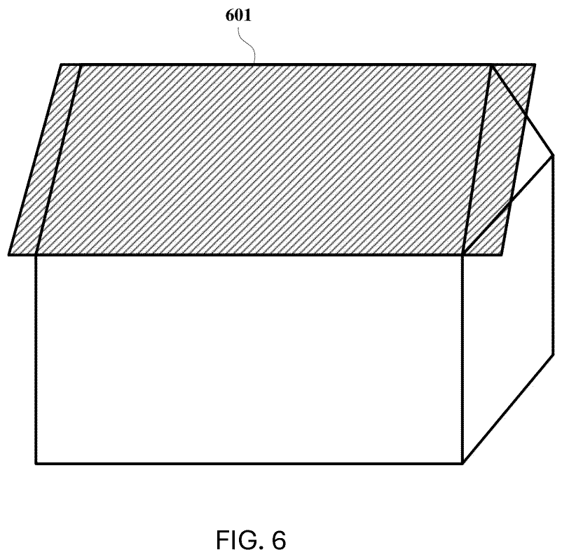

FIG. 5 is a flowchart illustrating a bird expulsion method using the bird expulsion system according to a preferred embodiment of the present invention. Referring to FIG. 5, the flow of the bird expulsion method comprises:

Step S501: Start.

Step S502: Initialize strategy parameters. First, when the control device 204 initiates operation, it reads user settings. For example, prior to use, the bird expulsion system performs a panoramic image capture of all regions. Subsequently, the user may preset coordinates of several expulsion locations within these regions according to requirements. Furthermore, regions (i.e., hotspots) for expelling birds and regions not requiring expelling birds for each expulsion location are selected in advance. These settings are read by the control device 204 in this step of initializing strategy parameters.

Step S503: Orient, via the moving mechanism, a lens of the image capturing device toward an expulsion location. Referring to FIG. 4, in step S503, the control device 204 controls the moving mechanism 201 to drive the lens of the image capturing device 202 to aim at a first expulsion location.

Step S504: Perform, via the lens of the image capturing device, a first image capture on the expulsion location to obtain a first image. The control device 204 controls the image capturing device 202 to perform image capture at the expulsion location to obtain an initial image of the expulsion location, that is, an image captured prior to performing the bird expulsion operation.

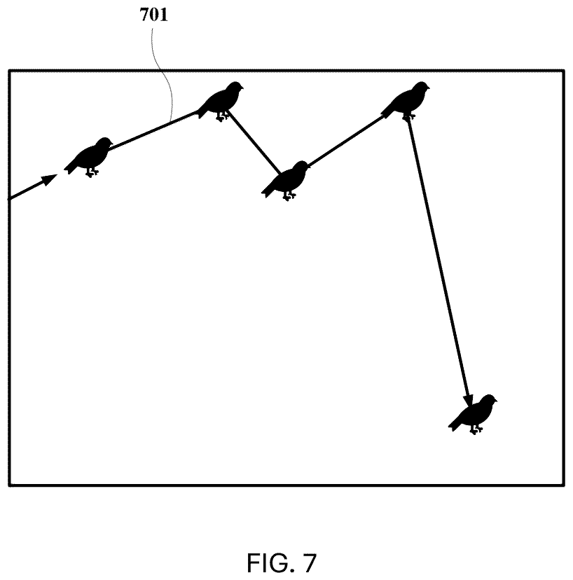

Step S505: Determine, via an intelligent image determination model, locations where a plurality of birds are present within the first image. The control device 204 can determine, via the intelligent image determination model, a specific location of birds within the first image. FIG. 6 is a schematic diagram illustrating a target expulsion area set for the bird expulsion system according to a preferred embodiment of the present invention. Referring to FIG. 6, in the present embodiment, since a user can set a region 601 requiring expelling birds for each expulsion location, the intelligent image determination model can only determine birds within the region 601 requiring expelling birds. Regarding regions outside the region 601 requiring expelling birds, even if birds are present, the intelligent image determination model may ignore the regions.

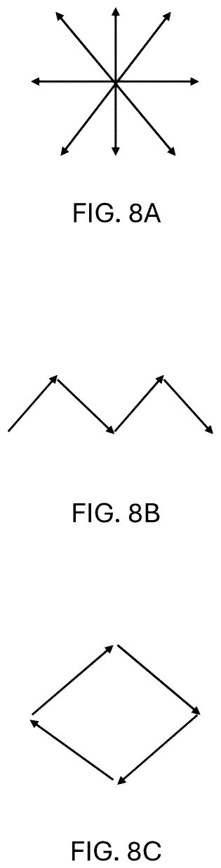

Step S506: Determine an activation of the expulsion device and a movement pattern of the moving mechanism based on the locations where the plurality of birds are present. FIG. 7 is a schematic diagram illustrating an aiming trajectory of an expulsion device 203 driven by a moving mechanism 201 of the bird expulsion system according to a preferred embodiment of the present invention. The control device 204 can pre-calculate a movement pattern of the moving mechanism 201 based on the aforementioned locations where the birds are present; that is, the control device 204 can pre-calculate, based on the locations where the birds are present, the movement pattern of the moving mechanism 201 according to an aiming trajectory 701 of the expulsion device 203.

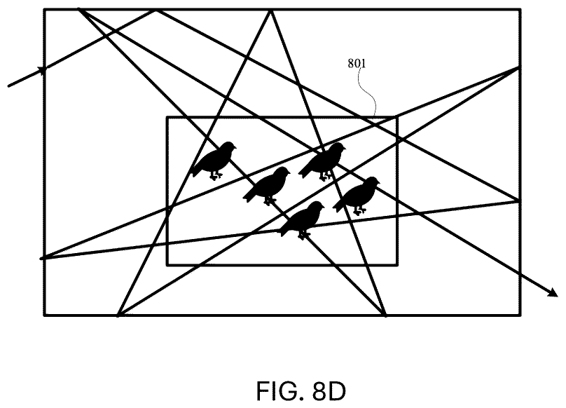

Step S507: Determine an expulsion strategy based on the expulsion device. In the present embodiment, one expulsion device 203 may be selected from available expulsion devices 203. For example, a laser module is selected as the expulsion device 203. Further, an expulsion strategy for emitting a laser beam is determined based on the selected laser module and historical data. FIGS. 8A to 8D are schematic diagrams illustrating expulsion strategies of an expulsion device 203 of the bird expulsion system according to a preferred embodiment of the present invention. Referring to FIGS. 8A to 8C, in the present embodiment, the laser module is utilized as an example. When the laser module moves to aim at, for example, a position where a first bird is present according to the trajectory shown in FIG. 7, it does not merely emit a laser beam. This is because if the laser beam is not seen by the bird, the bird will not be repelled thereby. Therefore, in the present embodiments shown in FIGS. 8A to 8C, three types of strategies for emitting laser beam are provided. For example, the strategy shown in FIG. 8A exemplifies a cross-pattern trajectory; the strategy shown in FIG. 8B exemplifies a sawtooth-pattern trajectory; and the strategy shown in FIG. 8C exemplifies a rhombus-pattern trajectory.

Furthermore, referring to FIG. 8D, for example, a small flock of birds is present within a threshold region 801. The flock of birds within the smaller region 801 requires more frequent monitoring to improve bird expulsion effectiveness. Therefore, in the present embodiment, a threshold value is set for the region. If an activity range of the flock of birds is within the region set with this threshold value, it is defined as a “small-scale flock.” This threshold value is a certain percentage of an area of a monitoring region. In the present embodiment, this expulsion strategy involves a laser beam moving randomly within a scanning range and reflecting upon encountering a boundary, thereby increasing a probability of an expulsion effect.

Step S508: Perform the expulsion strategy via the expulsion device and the moving mechanism. After the expulsion strategy is confirmed, the control device 204 controls the moving mechanism 201 and the expulsion device 203 to begin performing the aforementioned expulsion strategy.

Step S509: Perform a second image capture to obtain a second image after performing the expulsion strategy. After the expulsion strategy is performed for each of bird gathering sites, the control device 204 controls the image capturing device 202 to perform image capture on the expulsion location again to obtain an expulsion result image of the position, that is, an image captured upon completion of the bird expulsion operation.

Step S510: Analyze, via an intelligent image determination model, the second image and the first image to obtain expulsion effectiveness evaluation data. In this step S510, the control device 204 reactivates a local intelligent image determination model to analyze the first image captured prior to the bird expulsion operation and the second image captured after the bird expulsion operation, thereby obtaining the expulsion effectiveness evaluation data.

Step S511: Store the expulsion effectiveness evaluation data. The expulsion effectiveness evaluation data is stored by the control device 204 as historical data.

Step S512: Determine whether the expulsion strategy has been completed for all of the expulsion locations. If the expulsion strategy has not been completed for all of the expulsion locations, the control device 204 returns to Step S503 to re-perform the process until the expulsion strategy is completed for all of the expulsion locations, and then proceeds to Step S513.

Step S513: Perform a strategy review calculation according to the expulsion effectiveness evaluation data to change the expulsion strategy. In the present embodiment, the strategy review calculation may include, for example, comparing the historical data and the expulsion effectiveness evaluation data to perform: calculating a current expulsion rate for each of the locations; comparing the current expulsion rate and a historical expulsion rate for each of the locations to obtain an expulsion trend for each of the locations; and changing the expulsion strategy to a second expulsion strategy for each of the locations based on a historical expulsion quantity for each of the locations, a current expulsion quantity for each of the locations, and the expulsion trend for each of the locations.

By means of the above-mentioned strategy review calculation, the expulsion strategy can be changed to proceed with, for example, changing an expulsion duration of the expulsion device; changing a detection limit time of the expulsion device; changing the expulsion device, such as substituting the laser beam with a water gun or ultrasonic waves, etc.; changing an expulsion frequency of the expulsion device; and changing a specific expulsion coordinate position of the expulsion device. The above-mentioned strategy review calculation may be selectively performed using a general algorithm or using an artificial intelligence model. Generally speaking, this bird expulsion system adopts an edge computing manner. In a situation where computing power is insufficient, and expulsion mode selectivity and expulsion strategies are limited, artificial intelligence is not necessarily required; and utilizing a general algorithm is also a preferable option and can reduce power consumption of the bird expulsion system. The present invention is not limited thereto. When Step S513 is completed, the process returns to Step S503 to continue a next round of expelling birds.

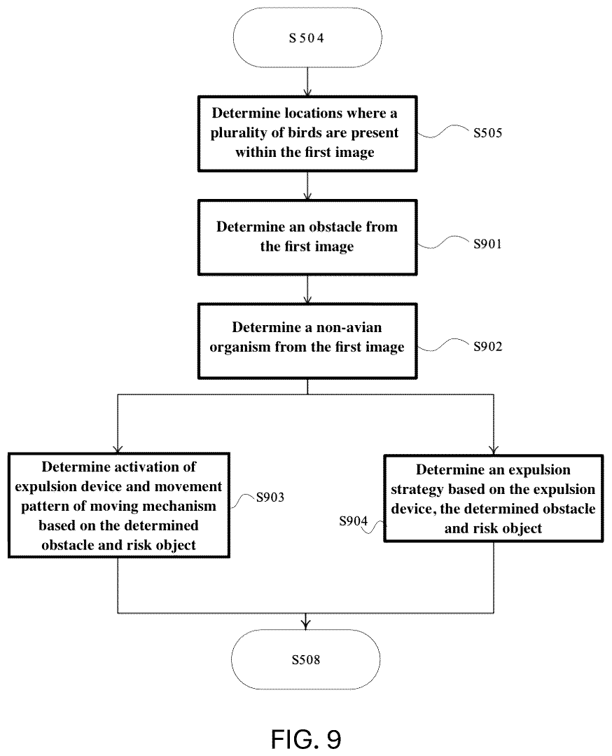

The above embodiment takes the roof in FIG. 7 as an example. The environment of the roof is relatively simple and does not have obstacles or risks, so the operation of the bird expulsion system can be relatively simple. However, after the environment changes, the bird expulsion method will also change accordingly. FIG. 9 is a flowchart illustrating a bird expulsion method using the bird expulsion system according to a preferred embodiment of the present invention. Referring to FIG. 9 and FIG. 5, the operation flow of the bird expulsion method further includes, between Step S504 and Step S508:

Step S901: Determine an obstacle from the first image via the intelligent image determination model.

Step S902: Determine a non-avian organism from the first image via the intelligent image determination model to perform risk avoidance. For example, an environment where the bird expulsion system is installed is a cattle shed. When expelling birds, it is highly likely to harm cattle; for instance, a laser beam striking the eyes of a cow eating feed may cause the cow to be frightened. Alternatively, the laser beam may also interfere with a person working. These are all situations where risk avoidance needs to be performed. The above-mentioned obstacle, non-avian organism, and the like can be marked in advance via the intelligent image determination model.

Step S903: Determine an activation of the expulsion device and a movement pattern of the moving mechanism based on the determined obstacle and risk object. This step is modified based on Step S506.

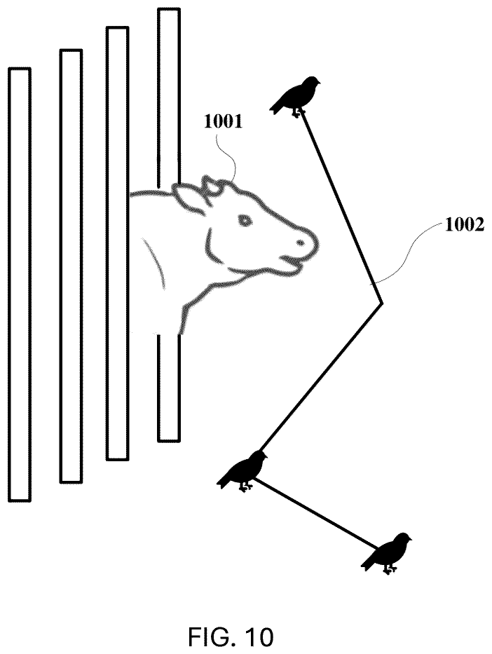

Step S904: Determine an expulsion strategy based on the expulsion device, the determined obstacle and risk object so as to avoid the determined obstacle and the risk object from an expulsion operation. This step is modified based on Step S507. FIG. 10 is a schematic diagram illustrating an aiming trajectory of an expulsion device 203 driven by a moving mechanism 201 of the bird expulsion system according to a preferred embodiment of the present invention. Referring to FIG. 10, the number 1001 indicates the determined obstacle or the risk object, and the number 1002 indicates the determined aiming trajectory that avoids the determined obstacle or the risk object 1001 from the expulsion operation. In this way, these obstacles can be avoided. In addition, when the expulsion strategy is performed, the laser beam is also prevented from covering the determined obstacle or the risk object 1001.

Although the above-mentioned embodiment has taken into consideration complex situations such as risks and obstacles, the actual situation may further include some potential locations where birds are present. The so-called potential location is a location where expelling birds is required, but the image capturing device 202 cannot determine the existence of the birds. Typically, such a location is relatively far away from a lens of the image capturing device 202. In another preferred embodiment, Step S506 may also determine the activation of the expulsion device and the movement pattern of the moving mechanism based on the potential location where birds are present. In the above-mentioned embodiment, the potential locations where birds are present may also be certain areas where the birds particularly easily gather, and which do not need to be determined by the intelligent image determination model. Therefore, the present invention is not limited thereto.

In summary, the preferred embodiment of the present invention provides a novel bird expulsion system. This system combines automation, intelligent image recognition, and dynamic strategy adjustment to implement efficient and targeted bird expulsion. This system first captures bird activities in a designated area via the image capturing device, and utilizes a built-in edge computing type of intelligent image determination model to precisely position the bird flock. Next, the system dynamically determines an aiming trajectory and an expulsion strategy for the expulsion device (such as a laser beam, a water gun, a sound wave device, etc.) based on the location where the birds are present, the quantity of the birds, and the hot zone where the birds are present. This strategy not only can be performed in a targeted manner, but also can perform self-optimization via the strategy review calculation according to expulsion effectiveness evaluation data (for example, an expulsion rate and an expulsion trend) after each bird expulsion operation, and automatically adjust a next expulsion behavior, such as changing an expulsion duration, a detection frequency, or even replacing the expulsion device. This design not only effectively avoids energy and time waste caused by a traditional sequential scanning mode, but also can provide a solution with more flexibility and adaptability in response to different scenes and habits of bird flocks. Therefore, the bird expulsion system of the present invention is capable of significantly improving expulsion efficiency while reducing interference with the environment, providing a smart solution for bird damage problems in fields such as agriculture and public facilities.

The specific embodiments described in the detailed description of the preferred embodiments are provided solely to facilitate the understanding of the technical content of the present invention and should not be construed as narrowly limiting the present invention to the above embodiments. Any modifications made without departing from the spirit of the present invention and the scope of the appended claims fall within the scope of the present invention. Therefore, the protection scope of the present invention shall be determined by the appended claims.

What is claimed is:

1. A bird expulsion method, adapted for a bird expulsion system, the bird expulsion system comprising a control device, a moving mechanism, an image capturing device, an intelligent image determination model, and an expulsion device, the bird expulsion method comprising:
setting, via the control device, at least one expulsion location;
orienting, via the moving mechanism, a lens of the image capturing device toward the at least one expulsion location;
performing, via the lens of the image capturing device, a first image capture on the at least one expulsion location to obtain a first image;
determining locations where a plurality of birds are present within the first image via the intelligent image determination model;
determining an activation of the expulsion device and a movement pattern of the moving mechanism based on the locations where the plurality of birds are present;
determining an expulsion strategy based on the expulsion device;
performing the expulsion strategy via the expulsion device and the moving mechanism;
performing a second image capture to obtain a second image after performing the expulsion strategy;
analyzing the second image and the first image via the intelligent image determination model to obtain expulsion effectiveness evaluation data;
storing the expulsion effectiveness evaluation data; and
performing a strategy review calculation according to the expulsion effectiveness evaluation data to change the expulsion strategy.

2. The bird expulsion method of claim 1, wherein after performing the first image capture on the at least one expulsion location via the lens of the image capturing device to obtain the first image, the method further comprises:
determining an obstacle from the first image via the intelligent image determination model.

3. The bird expulsion method of claim 2, wherein determining the activation of the expulsion device and the movement pattern of the moving mechanism based on the locations where the plurality of birds are present further comprises:
determining the activation of the expulsion device and the movement pattern of the moving mechanism based on the determined obstacle.

4. The bird expulsion method of claim 2, wherein determining the activation of the expulsion device and the movement pattern of the moving mechanism based on the locations where the plurality of birds are present further comprises:
determining the expulsion strategy based on the expulsion device and the determined obstacle to avoid the determined obstacle from an expulsion operation.

5. The bird expulsion method of claim 1, wherein the intelligent image determination model is an edge computing type of intelligent image determination model to reduce operation delay.

6. The bird expulsion method of claim 1, wherein the expulsion device comprises at least one of the following:
a water gun configured to perform an expulsion operation via water spraying;
an acoustic device configured to emit sound waves;
a laser module configured to emit laser beam for performing the expulsion operation;
an air gun configured to perform a physical expulsion operation; and
a sprayer configured to release a chemical agent or a water-based repellent.

7. The bird expulsion method of claim 1, wherein the moving mechanism is a control mechanism having Pan, Tilt, and Zoom (PTZ) capabilities.

8. The bird expulsion method of claim 1, wherein determining the activation of the expulsion device and the movement pattern of the moving mechanism based on the locations where the plurality of birds are present further comprises:
determining the activation of the expulsion device and the movement pattern of the moving mechanism based on a potential location where a second plurality of birds are present.

9. The bird expulsion method of claim 1, wherein after performing the first image capture on the at least one expulsion location via the lens of the image capturing device to obtain the first image, the method further comprises:
determining a non-avian organism from the first image via the intelligent image determination model to perform risk avoidance.

10. The bird expulsion method of claim 1, wherein performing the strategy review calculation according to the expulsion effectiveness evaluation data to change the expulsion strategy further comprises:
performing the strategy review calculation based on historical data and the expulsion effectiveness evaluation data to proceed with at least one of the following changes:
changing an expulsion duration of the expulsion device;
changing a detection limit time of the expulsion device;
changing the expulsion device;
changing an expulsion frequency of the expulsion device; and
changing a specific expulsion coordinate position of the expulsion device.

11. The bird expulsion method of claim 1, wherein performing the strategy review calculation according to the expulsion effectiveness evaluation data to change the expulsion strategy further comprises:
comparing historical data and the expulsion effectiveness evaluation data to perform:
calculating a current expulsion rate for each of the locations;
comparing the current expulsion rate and a historical expulsion rate for each of the locations to obtain an expulsion trend for each of the locations; and
changing the expulsion strategy to a second expulsion strategy for each of the locations based on a historical expulsion quantity for each of the locations, a current expulsion quantity for each of the locations, and the expulsion trend for each of the locations.

12. The bird expulsion method of claim 1, wherein when the at least one expulsion location comprises a plurality of expulsion locations, the method further comprises:
orienting, after storing the expulsion effectiveness evaluation data, the lens of the image capturing device toward a next expulsion location via the moving mechanism until the plurality of expulsion locations are completed for performing the expulsion strategy, and then performing the strategy review calculation to change the expulsion strategy.

13. A bird expulsion system, comprising:
a moving mechanism;
an image capturing device disposed on the moving mechanism;
an expulsion device disposed on the moving mechanism, wherein the image capturing device and the expulsion device are substantially aimed in the same direction; and
a control device coupled with the moving mechanism, the image capturing device and the expulsion device, and the control device comprising an intelligent image determination model, wherein the control device stores at least one expulsion location;
wherein the control device controls the moving mechanism to orient a lens of the image capturing device toward the at least one expulsion location;
wherein the control device controls the lens of the image capturing device to perform a first image capture on the at least one expulsion position to obtain a first image;
wherein the intelligent image determination model is utilized to determine locations where a plurality of birds are present within the first image;
wherein the control device determines an activation of the expulsion device and a movement pattern of the moving mechanism based on the locations where the plurality of birds are present;
wherein the control device determines an expulsion strategy based on the expulsion device;
wherein the control device controls the expulsion device and the moving mechanism to perform the expulsion strategy;
wherein after performing the expulsion strategy, the control device controls the lens of the image capturing device to perform a second image capture to obtain a second image;
wherein the intelligent image determination model is utilized to analyze the second image and the first image to obtain expulsion effectiveness evaluation data;
wherein the control device stores the expulsion effectiveness evaluation data; and
wherein the control device performs a strategy review calculation according to the expulsion effectiveness evaluation data to change the expulsion strategy.

14. The bird expulsion system of claim 13, further comprising:
a storage device coupled to the control device and configured to store the expulsion effectiveness evaluation data as historical data.

15. The bird expulsion system of claim 13, wherein the control device is configured to determine an obstacle from the first image via the intelligent image determination model,
wherein the control device determines the activation of the expulsion device and the movement pattern of the moving mechanism based on the determined obstacle.

16. The bird expulsion system of claim 15, wherein the control device is further configured to determine the expulsion strategy based on the expulsion device and the determined obstacle to avoid the determined obstacle from an expulsion operation.

17. The bird expulsion system of claim 13, wherein the intelligent image determination model is an edge computing type of intelligent image determination model to reduce operation delay.

18. The bird expulsion system of claim 13, wherein the expulsion device comprises at least one of the following:
a water gun configured to perform an expulsion operation via water spraying;
an acoustic device configured to emit sound waves;
a laser module configured to emit laser beam for performing the expulsion operation;
an air gun configured to perform a physical expulsion operation; and
a sprayer configured to release a chemical agent or a water-based repellent.

19. The bird expulsion system of claim 13, wherein the moving mechanism is a control mechanism having Pan, Tilt, and Zoom (PTZ) capabilities.

20. The bird expulsion system of claim 13, wherein the control device is further configured to determine the activation of the expulsion device and the movement pattern of the moving mechanism based on a potential location where a second plurality of birds are present.

21. The bird expulsion system of claim 13, wherein the control device is further configured to determine a non-avian organism from the first image via the intelligent image determination model to perform risk avoidance.

22. The bird expulsion system of claim 13, wherein the control device changes the expulsion strategy by:
performing the strategy review calculation based on historical data and the expulsion effectiveness evaluation data to proceed with at least one of the following changes:
changing an expulsion duration of the expulsion device;
changing a detection limit time of the expulsion device;
changing the expulsion device;
changing an expulsion frequency of the expulsion device; and
changing a specific expulsion coordinate position of the expulsion device.

23. The bird expulsion system of claim 13, wherein the control device performs the strategy review calculation to change the expulsion strategy further by:
comparing historical data and the expulsion effectiveness evaluation data to perform:
calculating a current expulsion rate for each of the locations;
comparing the current expulsion rate and a historical expulsion rate for each of the locations to obtain an expulsion trend for each of the locations; and
changing the expulsion strategy to a second expulsion strategy for each of the locations based on a historical expulsion quantity for each of the locations, a current expulsion quantity for each of the locations, and the expulsion trend for each of the locations.

24. The bird expulsion system of claim 13, wherein when the at least one expulsion location comprises a plurality of expulsion locations, the control device is further configured to:
orient, after storing the expulsion effectiveness evaluation data, the lens of the image capturing device toward a next expulsion location via the moving mechanism until the plurality of expulsion locations are completed for performing the expulsion strategy, and then performing the strategy review calculation to change the expulsion strategy.
